(19) United States
(12) Patent Application Publication
(10) Pub. No.: US 2019/0372131 A1
(43) Pub. Date: Dec. 5, 2019

(54) MANUFACTURING IMPERVIOUS BIPOLAR MATERIALS FROM POROUS GRAPHITE

(71) Applicant: eChemion, Inc., Corvallis, OR (US)

(72) Inventors: Alexander A. Bistrika, Corvallis, OR (US); Pavel Mardilovich, Munich (DE); Kevin Terrence Lewis, Portland, OR (US); Jordan Loos, Springfield, OR (US); Jacob Donovan Tenhoff, San Francisco, CA (US); Bill Jay Brooks, Lebanon, OR (US)

(21) Appl. No.: 16/480,032

(22) PCT Filed: Jan. 23, 2018
(86) PCT No.: PCT/US18/14926

§ 371 Date: Jul. 23, 2019

Related U.S. Application Data
(60) Provisional application No. 62/449,306, filed on Jan. 23, 2017.

(51) Int. Cl. H01M 8/0213; H01M 8/0226; H01M 8/0221; H01M 8/18

(52) U.S. Cl. CPC H01M 8/0213; H01M 8/188; H01M 8/0221; H01M 8/0226

(57) ABSTRACT

The present invention includes bodies of flexible expanded graphite or of rigid body porous graphite impregnated with blended polymer-wax treatments to create composite bodies that exhibit properties critical in the function of electrochemical systems, and methods of manufacturing the same. High electrical conductivity is an inherent attribute of the untreated graphitic material that is retained through the impregnation process, while attributes of extremely low permeability and high mechanical strength are added to the composite via the polymer-wax blend. In one embodiment of the invention, the attributes of low ionic permeability, high flexural strength, and high electrical conductivity are achieved to create a component that could be useful in Redox Flow Battery (RFB) systems.

### CROSS-REFERENCE TO RELATED APPLICATIONS

This application is based on and claims priority to U.S. Provisional Patent Application No. 62/449,306 filed Jan. 23, 2017 entitled “MANUFACTURING IMPERVIOUS BIPOLAR MATERIALS FROM POROUS GRAPHITE”.

### BACKGROUND OF THE INVENTION

Wax-impregnated graphite electrodes were first described in 1957 by Gaylor, Conrad, and Landerl, for use in polarography. More recently, flexible graphite composites have been described by U.S. Pat. Nos. 5,902,762 A and 6,613,252 B2, which aim to create porous flexible graphite sheets and a moldable graphite composite, respectively.

U.S. Pat. No. 6,673,289 B2 describes a process by which flexible graphite foil produced from expanded graphite particles is impregnated with resin, embossed, and cured for use “in a proton exchange membrane fuel cell”. U.S. Pat. No. 6,673,289 focuses on impregnating and curing a resin filler material in order to achieve the desired material properties for the final product. U.S. Pat. No. 6,413,663 B1, U.S. Pat. No. 6,468,686 B1, and continuation 2009/0061312 A1 pertain to fluid permeable flexible graphite electrodes, all with the express intent to increase the permeability of the graphite electrode and improve the process of manufacturing said components. U.S. Pat. No. 7,094,311 B2 describes a manufacturing process for bipolar plates made of expanded graphite foil impregnated with a resin. Therein was described a process by which to manufacture uncured resin impregnated graphite material, which is later heated to cure and thereby bind the components.

The process of producing flexible, binderless anisotropic graphite sheet material is referenced in U.S. Pat. No. 3,404,061 A. The process of which comprises the compression or compacting of expanded graphite particles under a predetermined load and in the absence of a binder. Expanded graphite particles are anisotropically aligned such that they have a “z” direction dimension which is as much as 80 or more times that of the original particle dimensions prior to expansion. This material can thus be compressed so as to form a substantially flat, flexible, integrated graphite sheet. The expanded graphite particles that are generally worm-like or vermiform in appearance, once compressed, maintain the compression set and alignment with the major surfaces on both sides of the compressed sheet. The density and thickness of the sheet material can be varied by controlling the degree of compression. The density of the sheet material can range from about 0.04 g/cc to about 2.0 g/cc. The flexible graphite sheet material exhibits an appreciable degree of anisotropy due to the alignment of graphite particles parallel to the major opposed, parallel surfaces of the sheet. In addition, the degree of anisotropy can increase upon roll pressing of the sheet material to higher density. In roll pressed anisotropic sheet material, the thickness, i.e. the direction perpendicular to the opposed, parallel sheet surfaces comprises the “z” direction and the directions ranging along the length and width of the major surfaces comprise the “x-y” directions. The thermal and electrical properties of the sheet are anisotropic by orders of magnitude as dictated by the properties in each the “z” and “x-y” directions.

In other prior art, such as U.S. Pat. No 20030025234 and U.S. Pat. No. 6,746,771, inventors have disclosed methods by which one may fill expanded graphite material with preferred resins to achieve desired final product properties. In addition, both patents focus on producing components useful only in the electrochemical fuel cell industry. US 20030025234, focuses on the creation of a component for fuel cells that is hydrophobic in nature. Wax-polymer blend manufacturing was described as early as the 1940's in U.S. Pat. No. 2,298,846. Much more recently, wax-based compositions, articles made therefrom, and methods of manufacture and their uses were described in US 20160015496 by Johnson et al.

### SUMMARY OF THE INVENTION

The present invention relates to a composite of flexible expanded graphite having opposed parallel, planar outer surfaces (hereafter referred to as “expanded graphite”) and a wax-polymer blend, which is solid when below the operating temperatures of an electrochemical system, impregnated therein. The invention is an electrically conductive and low ion-permeable component for an electrochemical system and a method of manufacture for said component. The method of manufacture can be tailored to allow for the impregnation of any porous graphite material with a wax-polymer mixture, said graphite materials consisting of, but not limited to, sintered body graphite plates, sheets, foils and the like as well as compressed expanded graphite plates, sheets, foils, and the like. Impregnation of said graphite material can consist of, but is not limited to, the full immersion of the graphic material into a molten liquid bath or reservoir of a wax-polymer mixture. In another embodiment of the invention, the composite uses rigid-body porous graphite having opposed parallel, planar outer surfaces and a wax-polymer blend impregnated therein. Also, any reference to use of expanded graphite may be understood to also extend to use of a rigid-body porous graphite in its place, unless otherwise stated.

For the purposes of the present invention, a blend may be defined as including a simple homogeneous mixture of wax and polymer, or any combination of a natural or synthetic wax, with a single polymer, binary, or tertiary co-polymer blend, or any combination of a functionalized olefinic polymer and/or co-polymer blend.

The combination of paraffin and expanded graphite has been extensively studied within the phase change materials (PCM) industry and related fields to thermal management. All the methods previously employed in this area seek to combine the individual components to achieve isotropic material properties and/or subsequently casting the isotropic mixture into a desired form factor. The wax-polymer constituents and concentrations can be adjusted in order to allow the final product to meet any electrochemical system design needs. For example, one embodiment of a wax-polymer blend could meet the needs of a Redox Flow Battery, whereas a different or similar wax-polymer blend could meet the needs of a Fuel Cell. References to electrochemical systems throughout the remainder of the invention shall be understood to encompass any electrochemical system which the final product could be useful in.

This invention may benefit an electrochemical energy storage system when used as a bipolar plate, current collector, electrode, or other likewise component thereof which requires the conduction of electricity through said component. In one embodiment of the present invention, the final product improves the efficiency of an electrochemical system by reducing ion cross-over/permeability when the invention is exposed to highly-acidic or oxidative electrochemistries. In a plurality of embodiments, the invention also lowers the electrical contact resistance between its outer planar surfaces and any advanced or basic architecture electrode material, such as carbon felt or planar copper current collectors, that it may come in contact with. The invention also improves upon the prior art by retaining a higher bulk electrical conductivity by maintaining the structural and electrical integrity of the original expanded graphite solid structure, thereby lowering the internal cell resistance within an electrochemical assembly. In one such embodiment, use of the materials described herein, and that are manufactured as described, may serve as lower cost bipolar plates within redox flow battery systems without sacrificing any impermeability or resistivity performance seen in the current state-of-the-art in said systems.

Composites manufactured from expanded graphite and a wax-polymer blend by way of the present invention exhibit a lower cost than the materials described in the prior art, but are demonstrated to yield equal to or better performance than materials described in the prior art. Furthermore, composites of this nature exhibit flexibility when compressed in a stack assembly as well as sufficient bending strength so as to withstand the handling of the composite during installation into an electrochemical system.

Also disclosed with the present invention is a method for manufacturing one embodiment of a low ion-permeable bipolar plate, sheet, and the like, from a stock of inexpensive expanded graphite material. The composite is manufactured by exposing the expanded graphite material to a homogeneous mixture of wax and a polymer blend held at a temperature above the melting point of the homogeneous mixture and allowing the homogeneous mixture to impregnate the expanded graphite. The polymer blend in the mixture may constitute a single polymer, binary, or tertiary co-polymer blend, or any combination of a functionalized olefinic polymer and co-polymer blend. The homogeneous mixture comprises any combination of solvent, disclosed here as a preferred natural or synthetic wax, and any combination of polymer or co-polymer blends, disclosed here as preferred thermoplastic polyolefins, which can form a homogeneous mixture with the solvent/wax. The combination of polymer or co-polymer blends can be any combination of a suitable natural, semi-synthetic, or synthetic polymer, or their respective precursors that can polymerize in situ. In one embodiment of the manufacturing method, the expanded graphite is partially or fully submersed in the homogenous mixture and allowed to auto-impregnate the graphite structure. In another embodiment of the manufacturing method, a pressure or pressure differential may be applied across the graphitic material to accelerate the impregnation process. In another embodiment of the manufacturing method, the expanded graphitic material may be pre-treated to improve the auto-impregnation characteristics of the material, wherein said pre-treating constitutes wiping off any detritus that may be present on one or both of the opposed, planar surfaces of the graphitic material with a non-abrasive or low-abrasion cloth and/or tissue.

The invention describes a process by which a porous graphite material is impregnated with a wax-polymer blend, hereafter referred to as the “treatment”. The opposed parallel, planar outer surfaces are subsequently wiped clean by an absorbent cloth, or similar, to remove excess treatment from the planar outer surfaces. The removal of the excess treatment improves the electrical contact resistance and bulk electrical conductivity of the composite. In one embodiment, the excess treatment is removed with a rigid blade. In another embodiment, the excess treatment is removed with a flexible blade. In another embodiment, the excess treatment is first removed with a blade of either a flexible or rigid nature and subsequently wiped clean with an absorbent cloth. In another embodiment, the excess treatment is removed with a high pressure air blade. Other methods and embodiments of removing the excess treatment from the outer planar surfaces are included in the present invention and shall be apparent to an individual familiar in the art of cleaning such surfaces.

The present invention renders an expanded graphite foil with a very low to non-existent permeability to fluids and/or ions. The resistance to fluid and/or ion permeation is provided by the combined properties of the composite and the non-polar characteristics of the treatment. The thickness of the expanded graphite materials can range in thickness according to system architecture design from as small as about 50 micrometers in thickness to as large as about 10 millimeters in thickness. In another embodiment, the electrical conductivity and/or contact resistance of the composite is improved by the addition of electrically conductive additives to the treatment, such as fine metal powders made of Al, Ga, In, Sn, Ti, Pb, Bi, or a combination thereof. Another embodiment uses the addition of non-metallic electrically conductive additives to the treatment, such as carbon nanotube powder, to improve the electrical conductivity and/or contact resistance of the composite.

In one embodiment, the invention is a bipole which serves as the electrical conduit for electrons moving from one cell of an electrochemical redox flow battery to another, and/or acting as a current collector for porting electrons in and out of the electrochemical stack, where the bulk electrochemical reactions are both in the electrolyte and at the surface of an electrode material that is in physical contact with at least one planar outer surface of the invention.

In one embodiment, the invention is manufactured in a continuous-feed roll-to-roll process. In one embodiment, the invention is practiced by immersing expanded graphite in a treatment comprised of 10% to 90% paraffin by mass and the remainder with ethylene vinyl acetate (EVA), with the treatment kept above the melting point of the homogeneous mixture. After a period of at least 5 minutes, the expanded graphite is removed from the bath and the excess treatment is removed from the surface. In another embodiment, the expanded graphite is placed into good thermal contact with the solidified treatment with at least one of the planar outer surfaces of the expanded graphite, is elevated above the melting point of the treatment, and allowed time for the treatment to impregnate the expanded graphite.

In one embodiment, the blend composition is tailored to provide extra resistance to chemical degradation in a predetermined electrochemical system, such as a Vanadium Redox Flow Battery. With some temperature and pressure assisted processing, dissimilar polarities may also be combined in support of this embodiment. In one embodiment the blend comprises a single polymer with carrier wax solvent. In another embodiment a binary, tertiary, or multi-polymer blend can be achieved to match the chemical compatibility of a given electrochemical application. Other embodiments are represented here as being tailored for other purposes or electrochemical systems which would be apparent to an individual skilled in the art of manufacturing products for electrochemical systems.

In one embodiment, expanded graphite is first impregnated with a pure dispersing solvent or carrier agent, such as a low viscosity wax, and is subsequently impregnated with a polymer blend, which may be of higher viscosity. In this embodiment, the dispersing agent acts as a bridge through which more viscous polymer blends may be able to impregnate the expanded graphite under appropriate temperatures and pressures. In another embodiment, the expanded graphite is first lined with a polymer blend and then submersed in a pure dispersing solvent or carrier agent, such as a low viscosity wax. In this embodiment, temperature and pressure may be controlled to further impregnate the expanded graphite with the carrier agent while pushing the polymer blend deeper into the expanded graphite. In this way the loading of any raw materials can be tailored to a specific electrochemical system.

In one embodiment the present invention is a composite material including a porous graphitic material having opposed parallel planar outer surfaces, wherein said porous graphitic material is impregnated with a solidified mixture in an amount of about 0.1-50.0% by weight, wherein the solidified mixture comprises a wax and a thermoplastic polymer that is miscible with the wax of the solidified mixture, and wherein said material composite is configured to prevent the crossover and permeation of ions in an electrochemical system. In another embodiment the solidified mixture remains a solid below about 65 degrees Celsius. In another embodiment the solidified mixture remains a solid below about 150 degrees Celsius. In another embodiment the solidified mixture is layered within the porous graphitic material with a first layer comprising the wax and a secondary layer comprising of the thermoplastic polymer. In another embodiment the thermoplastic polymer is chosen from the family of thermoplastic polyolefins. In another embodiment the electrical resistivity from a first planar outer surface to an opposed planar outer surface of the porous graphitic material is less than or about equal to 1×10⁻³ Ω-m. In another embodiment the solidified mixture further comprises electrically conductive additives. In another embodiment the solidified mixture further comprises a wax and a plurality of thermoplastic polymers miscible in the wax. In another embodiment the bending strength of the composite is greater than 5 MPa. In another embodiment the wax is paraffin. In another embodiment the thermoplastic polymer is ethylene vinyl acetate. In another embodiment the solidified mixture consists of about 70%-90% natural or synthetic wax by mass, about 10%-30% thermoplastic polymer by mass, and about 0.01-10% conductive additive by weight. In another embodiment electrically conductive additives added to the solidified mixture are chosen from the family of carbon conductors. In another embodiment electrically conductive additives added to the solidified mixture include Cu, Al, Au, Ag, and/or similar high conductivity metals. In another embodiment the mixture is layered within the porous graphitic material with a first layer consisting of the thermoplastic polymer and a secondary layer consisting of the natural or synthetic wax. In another embodiment the mixture is layered within the porous graphitic material with a plurality of layers that alternate between the natural or synthetic wax and the thermoplastic polymer. In another embodiment the mixture is layered within the porous graphitic material with a plurality of layers that alternate between the natural or synthetic wax and the homogeneously mixed solution of said wax and the thermoplastic polymer. In another embodiment the mixture is layered within the porous graphitic material with a plurality of layers that alternate between the thermoplastic polymer and the homogeneously mixed solution of said thermoplastic polymer and the natural or synthetic wax. In another embodiment the porous graphitic material is a sheet of expanded graphite has a thickness of about 0.05 mm-10 mm. In another embodiment the porous graphitic material is a rigid body of sintered graphite having a thickness of about 0.05 mm-10 mm. In another embodiment the rigid body of sintered graphite has a density of 0.04 g/cc to 2.0 g/cc. In another embodiment the porous graphitic material is an isotropic sheet of randomly oriented graphite plates having a thickness of about 0.05 mm-10 mm.

In yet another embodiment the present invention is a method of manufacturing a composite suitable for use as a component in an electrochemical system, including the steps of: providing a porous graphitic material having opposed parallel planar outer surfaces; providing a homogeneous mixture of a wax and a thermoplastic polymer miscible in said wax; exposing at least one of the planar outer surfaces of the porous graphitic material to the homogeneous mixture; heating the homogeneous mixture and graphitic material above the melt temperature of the homogeneous mixture; allowing the homogeneous mixture to impregnate the porous graphitic material; and cooling the porous graphitic material below the melting point of the homogeneous mixture. In another embodiment the method includes the step of removing excess homogeneous mixture from the porous graphitic material prior to cooling below the melting point of the homogeneous mixture. In another embodiment the method includes the step of removing excess homogeneous mixture from the porous graphitic material prior to cooling below the melting point of the homogeneous mixture with an element selected from a flexible blade, a rigid blade, an air knife, a cloth, and a tissue. In another embodiment the method includes the steps of reheating the composite to about the melting temperature of the homogeneous mixture after cooling the composite below the melting point of the homogeneous mixture, and buffing clean the composite with an absorbent cloth or a tissue. In another embodiment the method includes the step of applying pressure to the homogeneous mixture while it is in contact with the porous graphitic material. In another embodiment the method includes the step of applying vacuum to a first opposed planar surface of the porous graphitic material while a second planar surface of the porous graphitic material is in contact with the homogeneous mixture. In another embodiment the method includes the step of applying vacuum to a first opposed planar surface of the porous graphitic material for less than ten minutes prior to the step of exposing at least one of the planar outer surfaces of the porous graphitic material to the homogeneous mixture. In another embodiment heat is applied first to the homogeneous mixture only, and wherein the porous graphitic material starts on a spool and is then fed into the homogeneous mixture in its liquid phase at a rate of about 0.001 meter/minute to about 10 meters/min, then the porous graphitic material is fed out of the liquid phase and past a blade to remove excess homogeneous mixture, and then followed by cooling the porous graphitic material. In another embodiment the method includes expanded graphite compressed to a thickness of about 0.05 mm-10 mm.

In summary, the present invention is to impregnate raw expanded graphite of densities ranging from 0.04-2.0 g/cc by immersion in a wax-based treatment comprised of polyolefin plastic(s), polyolefin wax(es), or a combination thereof. Electrochemical systems using this material will afford similar or improved electrical resistance and impermeability performance over conventionally assembled electrochemical systems, that may use fluoropolymer composites, while simultaneously providing a lower component cost for the electrochemical system.

### BRIEF DESCRIPTION OF THE DRAWINGS

FIG. 1 is a schematic illustrating a semi-continuous process for producing an impervious bipolar material from flexible expanded graphite foil according to an embodiment of the present invention;

FIG. 2 is a schematic illustrating a batch process for impregnating porous graphite materials and removal of excess material process treatment according to an embodiment of the present invention;

FIG. 3 is a schematic cross section of graphite foil illustrating open porosity (left), surface porosity (middle), and internal porosity (right);

FIG. 4 is a schematic cross section of graphite foil illustrating the impregnation of two kinds of porosity, both rendering the graphite material impervious;

FIG. 5 is a conceptual illustration of expanded graphite pre- and post-compression showing the residual discontinuity in the graphite material; and

FIG. 6 is a flow chart showing a process for producing an impervious bipolar material from flexible expanded graphite foil according to an embodiment of the present invention.

### DETAILED DESCRIPTION OF THE INVENTION

The following explanations of terms and abbreviations are provided to better describe the present disclosure and to guide those of ordinary skill in the art in the practice of the present disclosure. As used herein, the singular forms “a” or “an” or “the” include plural references unless the context clearly dictates otherwise. The term “or” refers to a single element of stated alternative elements or a combination of two or more elements, unless the context clearly indicates otherwise. Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims. Unless otherwise indicated, all numbers expressing quantities of components, percentages, temperatures, times, and so forth, as used in the specification or claims are to be understood as being modified by the term “about.” Unless otherwise indicated, non-numerical properties such as continuous, homogeneous, and so forth as used in the specification or claims are to be understood as being modified by the term “substantially,” meaning to a great extent or degree. Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

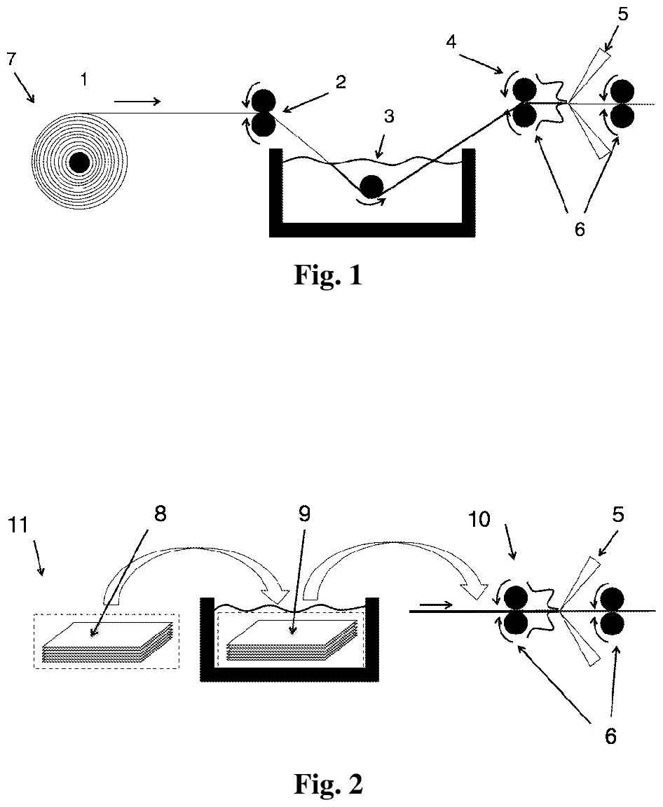

Referring generally to FIGS. 1-6, in any electrochemical system, multiple cells typically need to be electrically stacked in series with one another in order to achieve a desired electrical potential across the entire system. In order to be cost effective, these electrochemical systems will typically have reaction cells that are physically stacked in such a way as to allow the anode on one cell to be the cathode on the next cell, such that the stack of cells are all electrically in series with one another. In this mode of operation in an electrochemical system, every reactant on an anode side of one cell that leaks into the cathode side of its adjacent cell will result in a loss in efficiency or, in some cases, render the electrochemical system completely inoperable. For example, the component that separates these two cells in a redox flow battery is called a bipolar plate, on account of its need to function as both the cathode and anode for two different cells. An apparent loss for the system is any internal resistance that this component adds to the electrical system, but as presently described, it is equally important for this component, or bipolar plate in the case of redox flow batteries, to be impermeable, or at least functionally impermeable. Achieving complete impermeability of any component is very difficult to impossible and thus currently impractical. The present invention focuses on satisfying these two needs of impermeability and low electrical resistance with regard to this component as used in most electrochemical systems via a composite formed of low cost graphitic material and a wax-polymer mixture impregnated therein. An additional benefit of the present invention is that the high degree of customization that the mixture affords can allow an ordinary practitioner in the art to develop composites with customized material strengths, flexibility, and even chemical resistance to degradation. The variety of products and electrochemical systems that can be supported with this composite are extensive, and as such, a plurality of embodiments are also shared which each describe alternative designs that may be used for satisfying the needs of a plurality of different electrochemical systems. As a form of demonstrating how the invention can be put to practice to satisfy the needs of a vanadium redox flow battery system's bipolar plates, a novel method by which this bipolar composite may be manufactured is also shared.

Referring to FIG. 1, one embodiment of a continuous process 7 includes unspooling a roll of expanded graphite foil 1 through a set of feed rollers 2 passed through a molten bath of a wax and polymer treatment 3 and is collected by a spool-up on the other end. As the impregnated expanded graphite foil composite 1 departs the molten bath of treatment 3 the composite can be fed through a set of post-treatment calendaring rolls 6 to further improve the impermeability and conductivity of the composite. Furthermore, the composite can then be fed through a blade system 5 to remove the excess treatment 4. The removed excess treatment 4 can be returned to the molten bath of treatment 3.

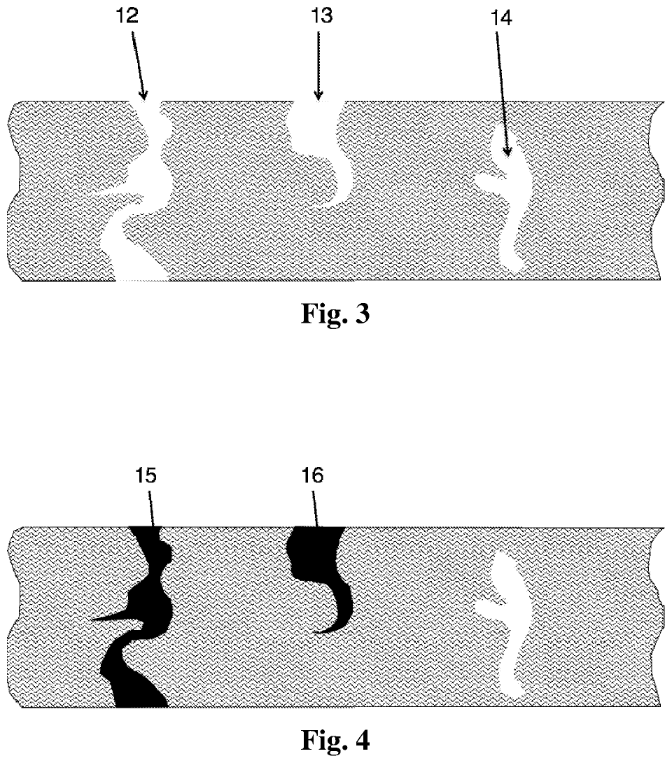

Referring now to FIG. 2, one embodiment of a batch process 11 includes immersing pieces of an expanded graphite foil 8 in a molten bath of a wax and polymer treatment 9. The impregnated expanded graphite foil composite 8 is then fed through feed rollers 6 and a blade system 5 to remove the excess treatment 10. The removed excess treatment 10 can then be returned to the molten bath of treatment 9. In some embodiments, the sheets, or pieces of an expanded graphite foil described above are placed on a rack and immersed into a molten bath, having first been evacuated and the void space filled with a reactive gas. In other embodiments, the void space is evacuated and filled with an inert gas phase. In other embodiments, the void space is evacuated only. In other embodiments, the blade system may be manually or autonomously operated to remove the excess treatment from the treated composite.

FIGS. 3-5 show how the wax and polymer treatments described above fill the porous regions of porous graphitic materials to help seal off the graphitic material to any ions that may try to permeate through the material due to either pressure or electrochemical potential. FIG. 3 specifically shows pores that go all the way through the graphitic material 12, partial pores 13 that are exposed to at least one of the two opposed planar surfaces of the graphitic material, and fully encapsulated pores 14 within the graphitic material that will not fill with treatment, and as such will not provide a leak path for permeation.

FIG. 4 shows the graphitic material after one of the above treatments is applied thereto. FIG. 4 shows specifically, in cross sectional view, filled through-hole pore with treatment 15, and filled partial pore with treatment 16.

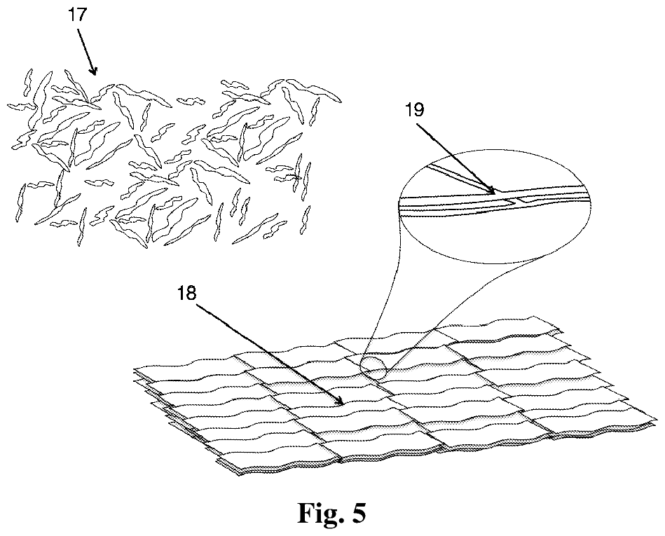

Referring more specifically to FIG. 5, the vermiform shape of graphite 17 is compressed into expanded graphite foil 18. Expanded graphite foil 18 includes cracks/pores/openings 19 in the calendared graphite that are susceptible leak paths for the catholyte and analyte to leak through during operation, these openings 19 are filled by the present invention. Expanded graphite foil 18 is commonly used as a gasket material that is compressed between two hard surfaces to form a seal. In one embodiment of creating the composite, an expanded graphite foil 18 can have all the void spaces within the foil 19, 12, 13 filled by the wax-polymer treatment 15, 16.

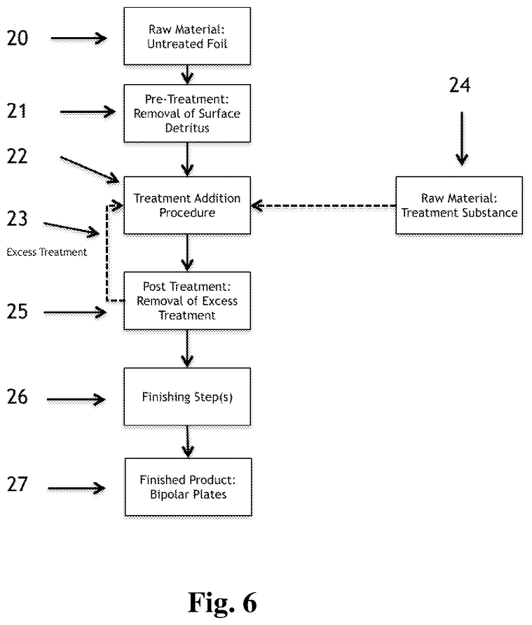

Referring more particularly to FIGS. 2 and 6, methods of producing impervious bipolar material from flexible expanded graphite foil are described herein. First, the components of the wax-polymer treatment 24 are chosen as paraffin and EVA. In addition to these two components, a conductive additive of activated charcoal is included in the treatment in order to improve electrical conductivity/contact between the composite and the components of the electrochemical system that the composite may come in contact with, including but not limited to the electrodes, the catholyte, the analyte, or the current collectors. The paraffin, EVA, and charcoal are heated beyond the melt temperature of EVA and combined at a ratio of about 80-90%, 10-20%, and 0.1-2% by weight, respectively. The mixture, hereafter referred to as the treatment, is then continually mixed in order to ensure that the activated charcoal remains adequately dispersed throughout the treatment.

Second, a die-cut or pre-formed sheet of calendared expanded graphite of a density about 0.8-1.5 g/cc and a thickness of about 0.4 mm-0.8 mm 8, 20 is pre-treated by wiping off any detritus from both opposed, planar surfaces of the sheet 21. This ensures that any detritus remnants from the manufacturing process of the sheet are removed from the surface, allowing the treatment to access all the pores of the graphite sheet that have a continuous flow path or access to at least one of the two planar, opposed surfaces. For significantly thick sheets of graphitic material, it stands to reason that the wiping down process shall also encompass the other four sides.

Third, the said graphite sheet is fully submersed into the mixed liquid bath of the treatment 22, 9. The sheet is allowed to stay inside the heated, mixed treatment bath for at least ten minutes and for as long as two hours, thus allowing sufficient time for the treatment to be drawn into the porous structure of the graphite plate through capillary forces and diffusion.

Fourth, the newly made composite is withdrawn from the liquid bath and laid upon a heated flat surface elevated to approximately the same temperature as the liquid bath 25. While the composite is on this heated surface, the excess treatment on the surfaces of the graphite sheet can then be wiped off of each side of the sheet with a rubber blade.

Fifth, the resulting composite can then be removed from the hot plate and placed on a rack where it can be allowed to fully cool 26. The excess treatment that was removed in the fourth step can be returned to the treatment bath for reuse 23.

Sixth, once cooled, the composite can be moved to a different heated surface that is just at or below the melt temperature of the treatment 26. While on this heated surface, any remaining treatment that was not removed with the rubber blade can be wiped off of both sides of the composite, exposing the graphite structure that constitutes a portion of the composite.

Finally, the composite can be removed from this last heated plate to yield the final product 27, which can be configured as bipolar plates.

Although the invention has been described in detail for the purpose of illustration based on what is currently considered to be the most practical and preferred embodiments of the application, it is to be understood that such detail is solely for that purpose and that the invention is not limited to the described embodiment. To the contrary, it is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A composite material comprising:
a porous graphitic material having opposed parallel planar outer surfaces,
wherein said porous graphitic material is impregnated with a solidified mixture in an amount of about 0.1-50.0% by weight,
wherein the solidified mixture comprises a wax and a thermoplastic polymer that is miscible with the wax of the solidified mixture, and
wherein said material composite is configured to prevent the crossover and permeation of ions in an electrochemical system.

2. The composite in accordance with claim 1, wherein the solidified mixture remains a solid below about 65 degrees Celsius.

3. The composite in accordance with claim 1, wherein the solidified mixture remains a solid below about 150 degrees Celsius.

4. The composite in accordance with claim 1, wherein the solidified mixture is layered within the porous graphitic material with a first layer comprising the wax and a secondary layer comprising of the thermoplastic polymer.

5. The composite in accordance with claim 1, wherein the thermoplastic polymer is chosen from the family of thermoplastic polyolefins.

6. The composite in accordance with claim 1, wherein the electrical resistivity from a first planar outer surfaces to an opposed planar outer surface of the porous graphitic material is less than or about equal to 1×10⁻³ Ω-m.

7. The composite in accordance with claim 1, wherein the solidified mixture further comprises electrically conductive additives.

8. The composite in accordance with claim 1, wherein the solidified mixture further comprises a wax and a plurality of thermoplastic polymers miscible in the wax.

9. The composite in accordance with claim 1, wherein a bending strength of the composite is greater than 5 MPa.

10. The composite in accordance with claim 1, wherein the wax comprises a paraffin.

11. The composite in accordance with claim 1, wherein the thermoplastic polymer comprises an ethylene vinyl acetate.

12. The composite in accordance with claim 1 wherein the solidified mixture consists of about 70%-90% natural or synthetic wax by mass, about 10%-30% thermoplastic polymer by mass, and about 0.01-10% conductive additive by weight.

13. A method of manufacturing a composite suitable for use as a component in an electrochemical system, comprising the steps of:
(a) providing a porous graphitic material having opposed parallel planar outer surfaces;
(b) providing a homogeneous mixture of a wax and a thermoplastic polymer miscible in said wax;
(c) exposing at least one of the planar outer surfaces of the porous graphitic material to the homogeneous mixture;
(d) heating the homogeneous mixture and graphitic material above the melt temperature of the homogeneous mixture;
(e) allowing the homogeneous mixture to impregnate the porous graphitic material; and
(f) cooling the porous graphitic material below the melting point of the homogeneous mixture.

14. The method of claim 13 further comprising the step of removing excess homogeneous mixture from the porous graphitic material prior to cooling below the melting point of the homogeneous mixture.

15. The method of claim 13 further comprising the step of removing excess homogeneous mixture from the porous graphitic material prior to cooling below the melting point of the homogeneous mixture with an element selected from a flexible blade, a rigid blade, an air knife, a cloth, and a tissue.

16. The method of claim 13 further comprising the steps of reheating the composite to about the melting temperature of the homogeneous mixture after cooling the composite below the melting point of the homogeneous mixture, and buffing clean the composite with an absorbent cloth or a tissue.

17. The method of claim 13 further comprising the step of applying pressure to the homogeneous mixture while it is in contact with the porous graphitic material.

18. The method of claim 13 further comprising the step of applying vacuum to a first opposed planar surface of the porous graphitic material while a second planar surface of the porous graphitic material is in contact with the homogeneous mixture.

19. The method of claim 13 further comprising the step of applying vacuum to a first opposed planar surface of the porous graphitic material for less than ten minutes prior to the step of exposing at least one of the planar outer surfaces of the porous graphitic material to the homogeneous mixture.

20. The method of claim 13 wherein heat is applied first to the homogeneous mixture only, and wherein the porous graphitic material starts on a spool and is then fed into the homogeneous mixture in its liquid phase at a rate of about 0.001 meter/minute to about 10 meters/min, then the porous graphitic material is fed out of the liquid phase and past a blade to remove excess homogeneous mixture, and then followed by cooling the porous graphitic material.
